(19) United States
(12) Patent Application Publication
(10) Pub. No.: US 2014/0090079 A1
(43) Pub. Date: Mar. 27, 2014

(54) BUSINESS DATA BROWSING SYSTEM MANAGING THE RETENTION PERIOD OF BUSINESS DATA

(71) Applicant: OKI ELECTRIC INDUSTRY CO., LTD., Tokyo (JP)

(72) Inventor: Yasuhiro KAWAKITA, Tokyo (JP)

(73) Assignee: OKI ELECTRIC INDUSTRY CO., LTD., Tokyo (JP)

(21) Appl. No.: 13/886,329

(22) Filed: May 3, 2013

(30) Foreign Application Priority Data
Sep. 24, 2012 (JP) 2012-209720

(51) Int. Cl. G06F 21/62

(52) U.S. Cl. CPC G06F 21/6218
USPC 726/27

(57) ABSTRACT

In a server of a business data browsing system, a management unit makes retention period information associated with business data of a user to be stored into a database. A determining unit is operative in response to a browsing inquiry of the business data held in a user terminal to reference the retention period information of the business data stored in the database to thereby determine whether or not browsing of the business data is permitted to produce a determination result. A transmitting unit transmits the determination result toward the user terminal. Thus, it is possible to improve the security level and convenience of business data held in the user terminal.

### BACKGROUND OF THE INVENTION

1. Field of the Invention

The present invention relates generally to a data browsing system, and more particularly to a business data browsing system for managing the retention period of business data.

2. Description of the Background Art

In recent years, mobile terminal devices have quickly spread, and may be used especially in situations where business persons visit destinations and on business trips. For example, mobile terminal devices, such as laptop personal computers (PCs), personal digital assistants (PDA), tablet terminals, smartphones and cellular phones, are utilized for business. Especially the volume of shipment of smartphones increases year by year, and smartphones are utilized in many situations such as of presenting explanatory or proposal materials of commercial products to customers at customers' offices and of reviewing explanatory materials or schedules on the way to visiting destinations.

When business data are carried out outside companies, the business data may often have to be stored into a mobile terminal in advance. In that case, protective measures for security are required against, e.g. disclosure of confidential information in case of the inadvertent loss of mobile terminals.

A solution for improving the security level of files is proposed, for example, in Japanese Patent Laid-Open Publication No. 2008-217057 (Reference 1). The solution proposed therein is directed to a system of distributing files to communication terminals so that files are controlled to selectively be stored in a random access memory (RAM) disk or a hard disk in accordance with the confidential level of the files. According to this solution, data stored in a storage area of the RAM (random-access memory) disk of a communication terminal can be displayed while the terminal is powered on. However, data in the storage area of the RAM disk disappears once the communication terminal is turned off. Files with higher confidential level are thus controlled to be stored in the RAM disk of communication terminals, so that data may be displayed upon receiving files on the terminals whereas, once the terminals are powered off, data would never be displayed even when the terminals are powered on again.

Japanese Patent Laid-Open Publication No. 2008-129625 (Reference 2) discloses a storage device with an access-restriction function which controls an access to the contents held in the device in accordance with the current moment or the current position of the device. By this means, for example, when the storage device is carried out from a region where an access thereto is allowed, the contents held in the storage device cannot be accessed.

The solution taught in Reference 1 would have higher security level. However, once the terminal device is powered off, it cannot display data again even when it is powered on again. Then, when it is desired to display a file in question again under offline environment, for example, the terminal device cannot receive redistribution of the file from a server, and this leads to lower convenience.

Reference 2 is silent about how to restrict an access to a content on another device when the other device has received the content.

References 1 and 2 do not address a new browsing system, such as of cloud computing, in which business data are held in a cloud server rather than an information processing device on a company network and a user terminal accesses the cloud server to acquire the business data.

### SUMMARY OF THE INVENTION

It is therefore an object of the present invention to provide a new and improved business data browsing system which is improved in security level and convenience of business data held in a user terminal.

According to the present invention, a server comprises a manager which makes retention period information associated with data, preferably business data, of the user to be stored into a database, a determiner which is operative in response to a browsing inquiry of the data held in a user terminal to reference the retention period information of the data stored in the database to thereby determine whether or not access to the data is authorized to produce a determination result, and a transmitter which transmits the determination result toward the user terminal.

According to an aspect of the present invention, when the retention period information has been updated, the transmitting unit may transmit the latest retention period information to the user terminal together with the determination result.

According to another aspect of the invention, the server may further include a retriever which is operative in response to an acquisition request from the user terminal to retrieve the business data from the database, and the transmitter may transmit the business data retrieved by the retrieving unit together with the retention period information associated with the business data.

According to still another aspect of the invention, the management unit may make the business data associated with a storage attribute to store the business data associated with the storage attribute into the database, and the transmitter may transmit the business data according to an acquisition request from the user terminal to the user terminal together with the storage attribute.

According to a further aspect of the invention, the storage attribute may be an allowance of storing or an allowance of caching.

According to a still further aspect of the invention, when the present date and time is within a retention period indicated by the retention period information, the determiner may determine that the browsing is permitted.

According to a yet other aspect of the invention, the manager may make the business data associated with positional information on a position where browsing is permitted to store the business data associated with the positional information into the database, and the determiner may determines, when a browsing place of the user terminal is in the vicinity of a position indicated by the positional information, that the browsing is permitted.

According to a yet further aspect of the invention, the determiner may further determine, when schedule information of the user matches a keyword or index with which the business data are tagged, that the browsing is permitted.

According to another aspect of the invention, the server may further include a receiver which is connected to a local area network of a business entity to which the user belongs and receives the business data from an information processing device on the local area network, and the manager may store the business data received from the information processing device into the database.

Also according to the present invention, a user terminal comprises a communication unit which is operative in response to operation of the user requesting browsing of data, preferably business data, held in the user terminal to send a browsing inquiry to a server, and a controller which is operative in response to a determination result sent from the server according to retention period information of the data to control whether or not the access to the data is authorized.

According to an aspect of the invention, when the server has determined that the browsing is not permitted because of a retention period indicated by the retention period information having expired, the controller may perform a control such as to delete the business data.

According to another aspect of the invention, when the server has determined that the browsing is permitted because of current time being within a retention period indicated by the retention period information, the controller may perform a browsing permission control of the business data.

According to still another aspect of the invention, when the server has determined that browsing is not permitted, although the current time is within a retention period indicated by the retention period information, because of the terminal being out of a browsing-allowable position which is indicated by the positional information on a position where browsing is permitted, the positional information being associated with the business data, the controller may perform a control such as to inhibit the browsing of the business data.

According to still another aspect of the invention, when the server has determined that the browsing is not permitted because of current time being within a retention period indicated by the retention period information, although schedule information of the user does not corresponds to a keyword with which the business data are tagged, the controller may perform a control such as to inhibit the browsing of the business data.

According to an yet still other aspect of the invention, when the browsing inquiry cannot be sent to the server, the controller may reference the retention period information associated with the business data held in the user terminal to determine whether or not the browsing is permitted.

According to a further aspect of the invention, the controller may perform an updating control so that the latest retention period information acquired together with the determination result is made associated with the business data held in the user terminal.

According to a still further aspect of the invention, the communication unit may send an acquisition request of the business data to the server, and the controller may perform a storing control over the business data, acquired from the server, in accordance with a storage attribute acquired together with the business data.

According to a yet further aspect of the invention, the controller may store the business data acquired from the server into a nonvolatile memory when the storage attribute is an allowance of storing, and into a volatile memory when the storage attribute is an allowance of caching.

Further according to the present invention, there is provided a non-transitory computer-readable storage medium storing a program for causing a computer to function as the aforementioned server. There is also provided a non-transitory computer-readable storage medium storing a program for causing a computer to function as the user terminal stated above.

In accordance with the present invention, it is possible to improve the security level and convenience or utility of business data held in a user terminal.

The inventive concept disclosed in the application may also be defined in ways other than in the claims presented below. The inventive concept may consist of several separate inventions particularly if the invention is considered in light of explicit or implicit subtasks or from the point of view of advantages achieved. In such a case, some of the attributes included in the claims may be superfluous from the point of view of separate inventive concepts. Within the framework of the basic inventive concept, features of different embodiments are applicable in connection with other embodiments.

### BRIEF DESCRIPTION OF THE DRAWINGS

The objects and features of the present invention will become more apparent from consideration of the following detailed description taken in conjunction with the accompanying) drawings in which:

FIG. 1 schematically shows the overall constitution of a business data browsing system according to a preferred embodiment of the present invention;

FIG. 2 is a schematic block diagram illustrating the constitution of the management server in the illustrative embodiment shown in FIG. 1;

FIG. 3 illustrates an example of business data stored in the business data database in the illustrative embodiment;

FIG. 4 is a schematic block diagram illustrating the constitution of a client terminal in the illustrative embodiment;

FIG. 5 is a flowchart useful for understanding the acquisition process of business data in the illustrative embodiment;

FIG. 6 is a plan view of an example of a display screen of the client terminal in the illustrative embodiment; and

FIG. 7 is a′flowchart useful for understanding the browsing process of business data in the illustrative embodiment.

### DESCRIPTION OF THE PREFERRED EMBODIMENT

Now, a preferred embodiment of the present invention will be described in detail, referring to the accompanying drawings. Throughout this patent application, like components or constituent elements are designated with the same reference numerals, and repetitive description thereon will be avoided.

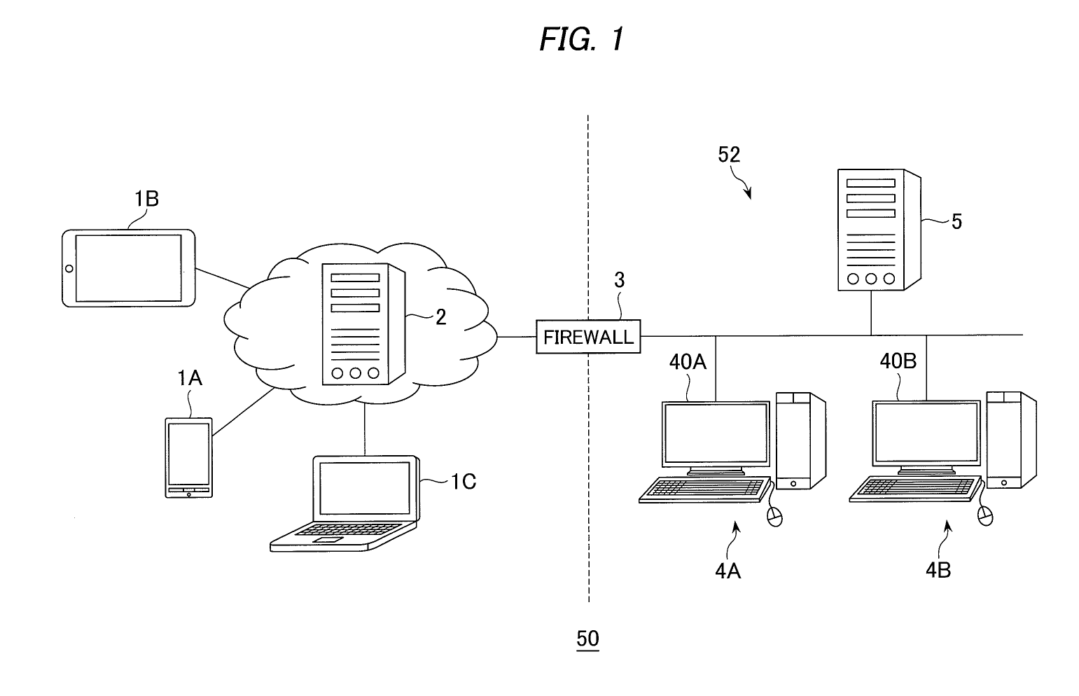

FIG. 1 schematically illustrates the overall constitution of a business data browsing system 50 according to an illustrative embodiment of the present invention. As can be seen from FIG. 1, the business data browsing system 50 includes client terminals (user terminals) 1A, 1B and 1C and a management server 2. The management server 2 is connected to an internal computer network 52 through a firewall 3. The internal computer network 52 may be, for example, a local area network (LAN), such as intranet, installed in the premises of a business entity, such as company. Such an internal computer network may be referred in this patent application to as company network. The company network 52 may include, for example, plural company personal computers (PCs) 4A and 4B, and a company server 5, which are interconnected as depicted. The personal computers 4A and 4B are equipped with respective display units 40A and 40B.

Note that, when it is not necessary to distinguish the specific client terminals 1A, 1B and 10 from each other, the terminals may generally be designated with a simple reference numeral 1. Similarly, when it is not necessary to distinguish the specific company personal computers 4A and 4B from each other, and also the displays 40A and 40B of the company personal computers from each other, the company personal computers and the displays may be designated with respective, general reference numerals 4 and 40.

In the system 50 shown in FIG. 1, the firewall (FW) 3 controls communication of the company network 52 with its outside, and ensures the security of the company network 52. In the company network 52, business data are processed by the company personal computers 4 and stored in the company personal computers 4 or the company server 5. The user can operate the company personal computers 4 and can upload desired business data to the management server 2. In the context, the term “business data” may cover in a broader sense any possibilities of including user data that may be confidential to a limited person or persons and/or effective to access, such as review, browse or display, at a limited time or period of time, place, or occasion. Similarly, the word “company” covers any forms of entities established by plural persons, including public entities.

The client terminals 1A and 1B, which may be mobile terminals, such as smartphone and tablet terminal, respectively, may be connected to the management server 2, for example through 3G public telecommunications network and a VPN (virtual private network) server, not shown, or via wireless LAN connection. The client terminal 10, which may be a laptop personal computer, may be connected to the management server 2 through the Internet or via wireless LAN connection.

In this way, each client terminal 1 can be connected to the management server 2 to acquire business data stored in the management server 2. When the user goes out from his or her office, he or she can thus manipulate the client terminals 1 outside the office to access, e.g. browse, desired business data.

When the client terminal 1 acquires the business data from the management server 2 and the business data are carried out to outside the company, protective measures for security are required against, e.g. disclosure of confidential information in case of the inadvertent loss of the mobile terminal 1.

However, the conventional solution of selecting an appropriate storage area, such as RAM (random-access memory) disk or hard disk, in accordance with the confidential level of business data in question would have higher security level, but was inconvenient due to, for example, the inaccessibility of data on display which is caused once the device was turned off even when it is powered on again.

In view of this difficulty in the conventional solution, in the business data browsing system 50 according to the illustrative embodiment, when the client terminal 1 browses business data acquired from the management server 2, browsing is controlled such that a browsing inquiry is sent to the management server 2 and, when the browsing is permitted by the management server 2, the client terminal 1 can browse the business data. This improves the security level and convenience of business data held in the client terminals, i.e. user terminals, 1.

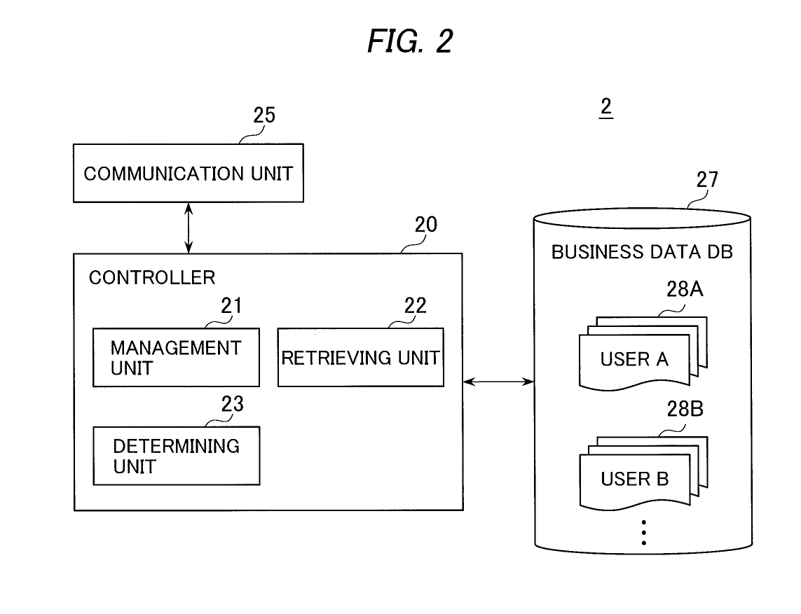

Now, the basic configuration of the management server 2 and the client terminal 1 included in the business data browsing system 50 according to the embodiment will be described. FIG. 2 is a schematic block diagram illustrating the constitution of the management server 2 in the present embodiment. As shown, the management server 2 includes a controller 20, a communication unit 25 and a business data database (DB) 27.

The communication unit 25 has the function of establishing a communication connection to an external device to transmit or receive data. The communication unit 25 in the illustrative embodiment receives business data through the firewall 3, for example, from the company personal computers 4 included in the company network 52. The communication unit 25 is also operative in response to requests from the client terminals 1 to transmit business data or the like to the client terminals 1.

The controller 20 is adapted to control the constituent components of the management server 2. More specifically, the controller 20 in the illustrative embodiment includes a management unit 21 which manages business data so as to store the business data specific for users in the business data database 27, a retrieving unit 22 which retrieves the data in the business data database 27 in response to requests from the client terminals 1, and a determining unit 23 which determines whether to allow the business data to be browsed or accessed.

The management unit 21 manages the storage of business data uploaded by the users from the company network 52 through the communication unit 25 into folders in the business data database 27 specific for the respective users. The management unit 21 is also adapted to update and delete the business data in accordance with users' requests. In this case, the management unit 21 may be adapted to tag business data with keywords or indices extracted from the business data to store the business data thus tagged in folders of the business data database 27. Such keywords may be, for example, proper nouns such as company names and products' names, and location expression such as spot names and addresses, telephone numbers, email addresses, and so on. The management unit 21 may reference a dictionary or directory database, not illustrated, which stores keywords for tagging in advance, to thereby obtain such keywords.

The retrieving unit 22 is adapted to search the business data database 27 for appropriate business data in accordance with an acquisition request from the client terminals 1. More specifically, the retrieving unit 22 uses file names, tags or keywords which are included in acquisition requests to search for business data appropriate for the requests.

Business data retrieved by the retrieving unit 22 will be transmitted to client terminals 1 which have originated the requests through the communication unit 25. Business data stored in the business data database 27, when associated with storage attributes or information on retention periods or the like, will be transmitted together with the storage attributes or the information on retention periods or the like to the client terminals 1.

The retrieving unit 22 may be adapted to transmit, when the retrieving unit 22 retrieves a plurality of business data items by means of tags, a list of the plurality of business data items to the client terminal 1 through the communication unit 25 as a search result.

The determining unit 23 is adapted to be responsive to an inquiry, transmitted from a client terminal 1, for browsing business data owned by the client terminal 1 to reference retention period information or the like associated with that business data stored in the business data database 27 to thereby determine whether or not the browsing is to be permitted. The determination result by the determining unit 23 is transmitted through the communication unit 25 to the client terminal 1 which has originated the inquiry.

In the illustrative embodiment, for example, in a case where the business data stored in the business data database 27 are associated with browsing retention period information as a browsing condition, the determining unit 23 determines whether or not the browsing is permitted depending on the current time falling within the range of browsing retention period. More specifically, the determining unit 23 determines to permit the browsing when the current time is within the browsing retention period, and not to permit the browsing when the browsing retention period has lapsed.

Also in the illustrative embodiment, in a case where the business data stored in the business data database 27 is associated as a browsing condition with information on a position where browsing is permitted, the determining unit 23 may determine whether or not the browsing is permitted depending on the client terminal currently resides in the vicinity of the position where the browsing is permitted.

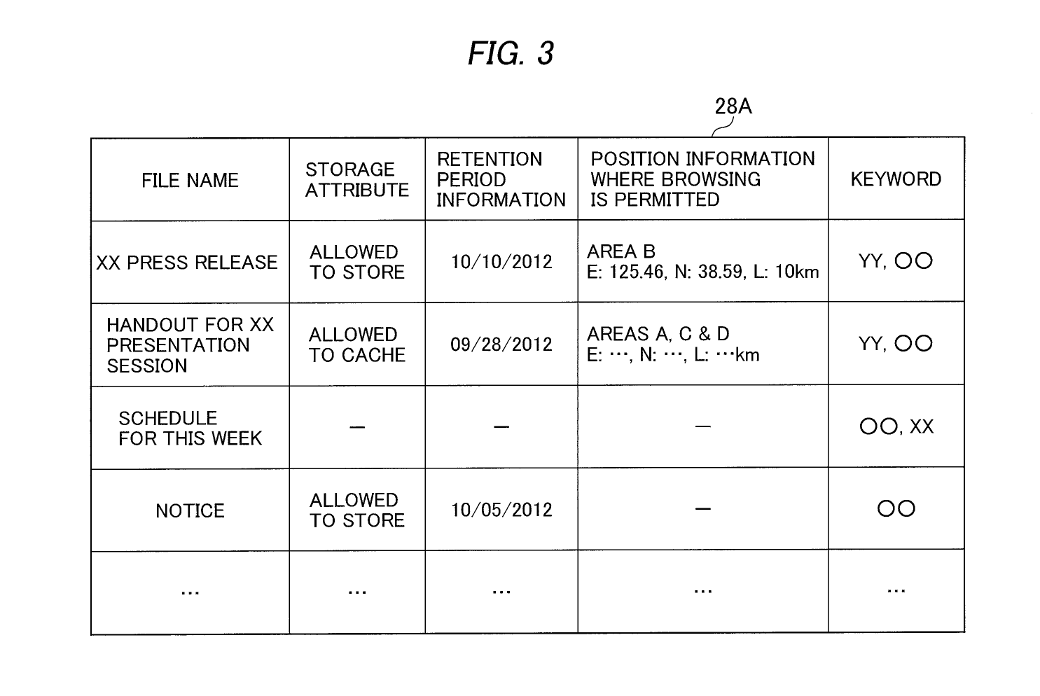

The business data database 27 stores business data uploaded from users on a user-by-user basis. For example, as illustrated in FIG. 2, the business data database 27 stores a plurality of business data items 28A of a user A and a plurality of business data items 28B of a user B. FIG. 3 illustrates an example of the business data items 28A of the user A stored in the business data database 27. As understood from the figure, for example, the business data database 27 stores the file name, storage attribute, retention period information, positional information of a position where browsing is permitted, and keywords of each business data item associatively with each other.

The storage attribute, the retention period information, and the positional information where browsing is permitted may be associated with business data in advance, or may be set by the user when business data are uploaded. The Storage attribute, the retention period information, the positional information where browsing is permitted may be arbitrarily updated to the latest information by the administrator or the user.

The storage attribute defines limitation on how the business data to be held by a client terminal 1 are to be stored in the client terminal 1. For example, the storage attribute includes information indicating “allowed to hold” and “allowed to cache”. The indication “allowed to hold” represents that data are allowed to be held in a nonvolatile memory, or storage, that is, a storage area where data do not disappear when powered off, of the client terminals 1. The indication “allowed to cache” represents that data are allowed to be temporarily stored in a volatile memory, but not held in a nonvolatile memory, of the client terminals 1. The volatile memory refers to a cache memory which is a storage area where data disappear when powered off or when having terminated an active application, particularly an application for utilizing the business data browsing system 50 of the illustrative embodiment. The restriction is imposed in this way when being stored in the client terminals 1 on how to hold business data, and thus the security level can be improved.

The retention period information defines limitation on a period of time in which the client terminals 1 can hold, or browse, business data. In other words, the retention period defines a period of time in which business data in question are effective to store or access. The retention period may be, for example, a temporal term, a time period of the day, a day or days of the week or month, or any forms of designating a period of time. The client terminal 1 can browse business data when the current time is within the retention period. When the retention period has expired, the business data held in the client terminals 1 are deleted from the client terminals 1. In that way, the security level and convenience can be improved. For example, a catalog or the like, when public, may be held in the client terminal 1 for carrying out without setting a retention period. By contrast, a proposal document, an explanatory material, a press release and the like, when secret, will have retention periods thereof set to enhance the security level since they are riskier in leakage. In this way, in the browsing system 50 according to the illustrative embodiment, the retention period can be set for each data item or file.

The positional information of a position or area where browsing is permitted or authorized is for use in limiting positions or region at which a client terminal 1 can browse, i.e. display, business data. When the client terminals 1 are located in or around positions or an area where browsing is permitted, the client terminals can browse business data. When the client terminals 1 are not located in positions where browsing is permitted, they are inhibited from browsing business data. The security level and convenience can thereby be improved. Specific examples of the positional information where browsing is permitted may be positional expression such as an address, a spot name, numeric expression such as latitude and longitude, the a real name of a region, e.g. the name of an administrative district, or the like. The example illustrated in FIG. 3 uses the names of administrative regions, such as A, B and C, and numeric expression of latitude and longitude and so one, such as 38.59N (North), 125.46 E (East), and 10 km L (Length, i.e. distance).

The example illustrated in FIG. 3 is directed to the case where the business data are associated with the retention period information and the positional information where browsing is allowed as browsing conditions. In addition or alternative thereto, time period of the day information in which browsing is permitted may be associated with business data as a browsing condition. For example, the browsing system 50 according to the illustrative embodiment may be adapted to control browsing so that the browsing is only allowed in a retention period and in a period of time of the day, e.g. 8:30 to 18:00, in which browsing is permitted.

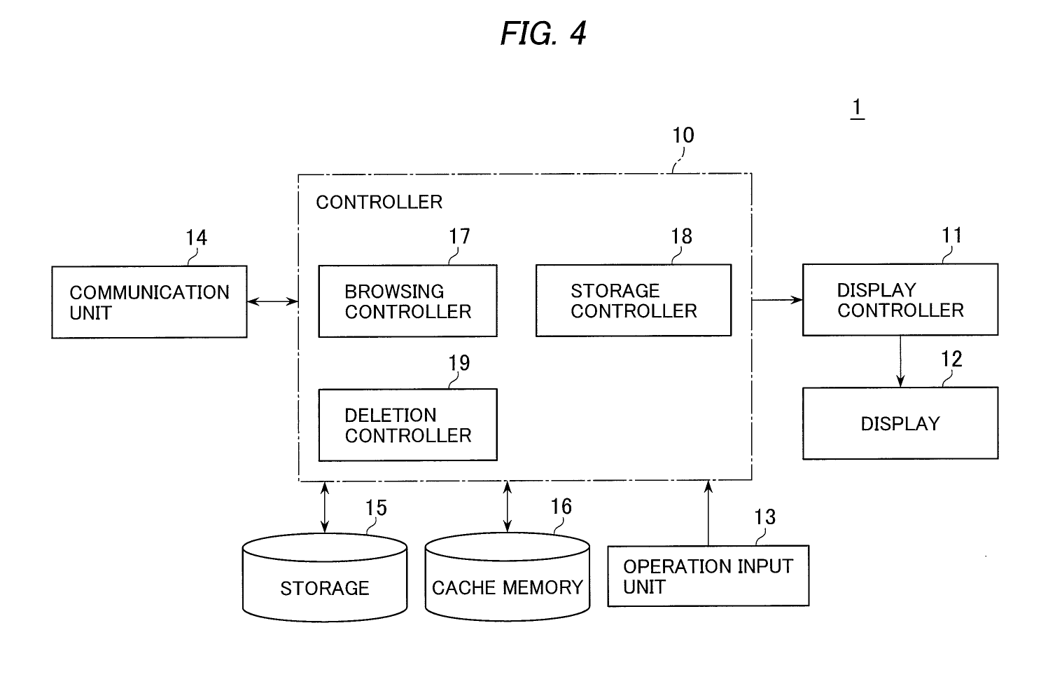

In the above, the management server 2 in the illustrative embodiment has been described on its specific constitution. Next, with reference to FIG. 4, description will be made on a specific constitution example of the client terminals 1 in the illustrative embodiment.

The client terminals, or user terminals, 1 in the illustrative embodiment are a mobile type of information processing devices, and may be utilized by the user outside the company. The client terminals 1 may be any of various types of devices, such as a smartphone, a laptop personal computer, and a tablet terminal as illustrated in FIG. 1. The following description will be focused on the principal components common to such a verity of devices applicable to the client terminals 1.

FIG. 4 is a schematic block diagram illustrating the constitution of the client terminals 1 in the illustrative embodiment. As seen from the figure, the client terminal 1 includes a controller 10, a display controller 11, a display 12, an operation input unit 13, a communication unit 14, a storage 15, and a cache memory 16, which are interconnected as shown.

The controller 10 functions as controlling the components of the client terminal 1. For example, the controller 10 controls those components in response to a user operation made on the operation input unit 13. The controller 10 is also responsive to the user operation to cause the communication unit 14 to send a business data acquisition request to the management server 2. The business data acquisition request is for use in acquiring business data to be stored in client terminals 1, and includes, for example, the file name and tag information of business data. The controller 10 may be adapted to acquire from the management server 2 a list of business data of the user that he or she has stored in the business data database 27 of the management server 2 on the company network 52 to display the list on the display 12. The controller 10 may prompt the user to select business data on the list thus displayed.

The controller 10 in the illustrative embodiment includes, as shown in FIG. 4, a browsing controller 17, a storage controller 18, and a deletion controller 19 as its functional components.

The storage controller 18 serves to control how to store business data acquired from the management server 2 through the communication unit 14 according to the storage attribute associated with the business data. Specifically, the storage controller 18 controls business data so that, when the business data are associated with the storage attribute thereof representing “allowed to store”, meaning allowance of storing, the business data will be stored or recorded in the storage 15 which is a nonvolatile memory, and, when the business data are associated with the storage attribute representing “allowed to cache”, meaning allowance of caching, the business data will be stored or recorded in the cache memory 16 which is a volatile memory.

The browsing controller 17 is responsive to a browsing operational instruction for business data being entered on the operation input unit 13 to cause the communication unit 14 to send a browsing inquiry of the business data to the management server 2. The browsing operational instruction for the business data may be an instruction generated in response to the user touching the display 12 at the file name of business data displayed thereon, for example. The display 12 may have its display screen consisting of a touch panel, as will be described later on.

The browsing controller 17 serves to be responsive to a determination result of the management server 2 on whether or not the browsing is permitted to perform a browsing permission control or a browsing inhibition control. Specifically, when it is determined that browsing is permitted, the browsing controller 17 instructs the display controller 11 to display business data currently held in the storage 15 or the cache memory 16. By contrast, when it is determined that browsing is not permitted, the browsing controller 17 performs a control of inhibiting the browsing such that the business data which is asked for browsing will not be displayed.

When it is determined that browsing of business data is not permitted because of the retention period having lapsed, the browsing controller 17 instructs the deletion controller 19 to delete the business data. When it is determined that browsing of business data is not permitted because of departing from a position where the browsing is permitted, the browsing controller 17 simply performs the browsing inhibition control.

In this way, the client terminals 1 in the illustrative embodiment are adapted to send a browsing inquiry to the management server 2 when business data acquired from the management server 2 and stored in a client terminal 1 are to be browsed on that client terminal 1. Business data may be associated with retention period information when acquired together therewith from the management server 2, and the retention period information may be updated on the management server 2. In case of such circumstances, the client terminal 1 is adapted to send a browsing inquiry to the management server 2 whenever browsing is requested.

The browsing controller 17 may be adapted to perform the browsing inhibition control whenever the terminals 1 are offline. Alternatively, the browsing controller 17 may use, during offline, the retention period information associated with business data stored in a client terminal 1 to determine whether or not browsing is permitted. The browsing controller 17 may determine whether to permit browsing in the same way as the determining unit 23 of the management server 2. In this case, the browsing controller 17 sends a browsing inquiry to the management server 2 when that client terminal 1 is placed online, so that, when the retention period has expired, the browsing controller 17 instructs the deletion controller 19 to delete the business data concerned.

In this way, according to the illustrative embodiment, business data held in the client terminals 1 are controlled to be browsed when it is determined based on the retention period information thereof that browsing is permitted by the management server 2, thereby improving the security level of business data carried out to outside the company. Moreover, the security level is ensured by determining whether or not browsing is permitted at the time of browsing, and therefore business data even with higher confidentiality can be stored in the client terminals 1. It is not necessary to receive business data from the management server 2 each time of browsing, and thus convenience improves.

When the client terminals are offline, the retention period information held in the client terminals 1 are used for determining whether or not browsing is permitted. In that case, the client terminals may be configured to send, when placed online later on, a browsing inquiry to the management server 2. In this way, it is possible to perform a flexible control depending on a situation.

The deletion controller 19 is adapted to be responsive to the management server 2 having determined that the browsing of business data are not permitted due to the retention period thereof having elapsed to delete the business data concerned held in the storage 15 or the cache memory 16. Thus, the browsing system 50 according to the illustrative embodiment can also manage business data which have been transmitted to the client terminals 1 from the management server 2, in other words, which have been carried out to outside the company.

The display controller 11 controls the display 12 to display various images or windows thereon. More specifically, the display controller 11 in the illustrative embodiment is operative in response to instructions from the browsing controller 17 to control the display 12 to display business data thereon. The display controller 11 is also adapted to be responsive to the operation of the user received by the operation input unit 13 to control the display screen.

The display 12 is a visual display device having its display screen, or viewing area, on which a variety of display images or windows may be displayed under the control of display controller 11. The display 12 may be implemented by a liquid crystal display (LCD), an organic light-emitting diode (OLED) display, a cathode-ray tube (CRT) or the like.

The operation input unit 13 is a device for sensing the operation of the user, and may be implemented by, for example, a touch panel, buttons, switches, a keyboard and/or keypad, and/or a pointing device such as a mouse, and so on.

The storage 15 is a nonvolatile memory, which has its storage area where data do not disappear even when the client terminals 1 are turned off. Specifically, the storage 15 may be implemented by a hard disk drive (HDD), a flash memory, a magnetoresistive random-access memory (MRAM) or the like. The storage 15 may have program sequences stored which control the controller 20 to perform various processes.

The cache memory 16 is a volatile memory, which has its storage area where data disappear in response to the client terminals 1 being turned off, or to an application for browsing business data being terminated. In this way, the cache memory 16 has the function of storing data temporarily. The cache memory 16 may be implemented by a high-speed storage device provided in a central processing unit (CPU), a static random-access memory (SRAM) or the like.

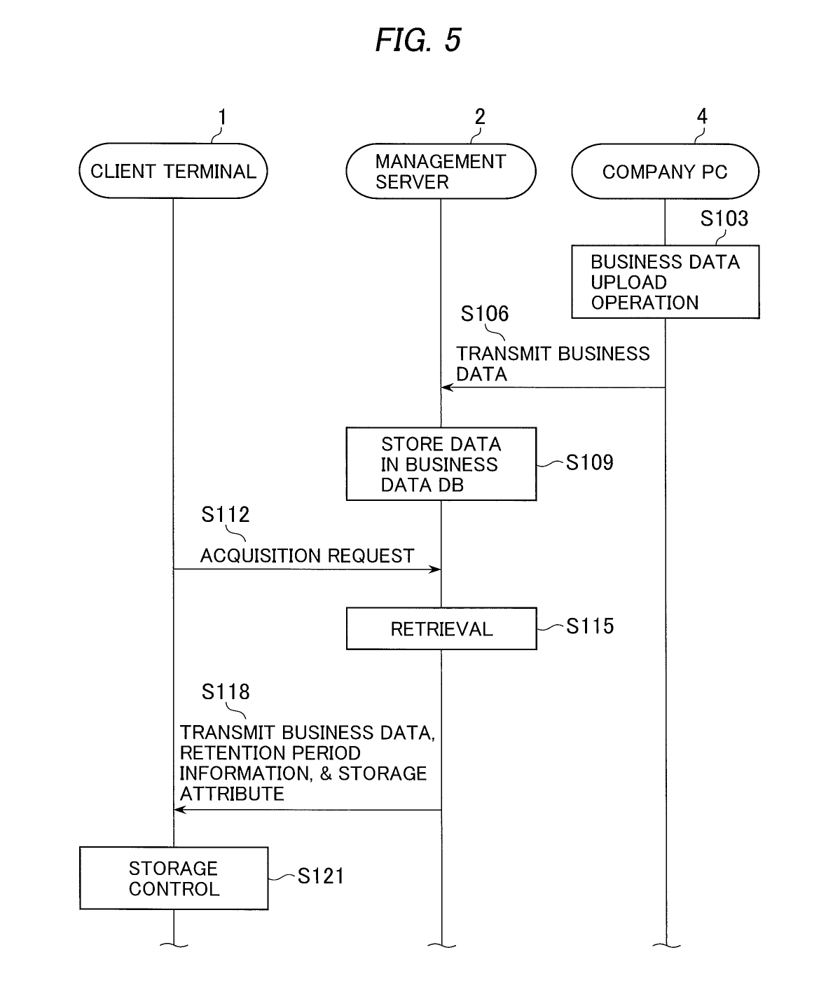

In the above, the components of the management server 2 and the client terminals 1 in the illustrative embodiment have been described in detail. Now, it will be specifically described how the browsing system 50 operates according to the illustrative embodiment. With the browsing system 50 of the illustrative embodiment, an acquisition process of business data and a browsing process are performed. In the acquisition process, the client terminals 1 to be carried out to outside the company acquire business data uploaded to the management server 2 on the company network 52. In the browsing process, business data are browsed at the client terminals 1. With reference to FIGS. 5, 6 and 7, the acquisition process of business data and the browsing process will be described in order.

FIG. 5 is a flowchart useful for understanding the acquisition process of business data in the illustrative embodiment. In the figure, at step S103, a company personal computer 4 first accepts the operation of the user for uploading business data. In the uploading operation, the user may, for example, drag and drop the icon of desired business data stored in, and shown on the display 40 of, his or her company personal computer 4 into the window of his or her folder in the management server 2 also shown on the display screen to thereby copy the data.

At step S106, that company personal computer 4 transmits the business data thus operated for uploading to the management server 2, which is the uploading of business data.

At step S109, the management unit 21 of the management server 2 stores the business data transmitted from the company personal computer 4 into the folder, i.e. storage area, prepared for that user in the business data database 27. In this case, the management unit 21 may extract a keyword or index from the business data and in turn tag the data with the keyword to store the data.

At step S112, in the client terminal 1, the application for utilizing the business data browsing system 50 according to the illustrative embodiment is started, and an acquisition request of the business data is transmitted to the management server 2.

At step S115, the retrieving unit 22 of the management server 2 in turn receives the acquisition request from the client terminal 1 to search the business data database 27 for the requested business data. For example, the retrieving unit 22 may use the file name and/or keyword included in the acquisition request to retrieve the business data. The management server 2 may be responsive to an access from the client terminal 1 of that user to transmit a list of the business data stored in his or her folder to that client terminal 1, and the retrieving unit 22 may reference the list to retrieve the business data in question based on the list to transmit the retrieved business data.

Subsequently at step S118, the management server 2 transmits the retrieved business data to the client terminal 1 which has originated the acquisition request. At that time, the management server 2 may transmit a storage attribute, retention period information or positional information where browsing is permitted, if associated with the business data in question, to the client terminal 1 together with the business data.

Then, at step S121, the client terminal 1 receives and stores the business data thus transmitted. At that time, if the client terminal 1 receives the storage attribute together with the business data, it performs a storing control in accordance with the storage attribute. More specifically, when the storage attribute indicates “allowed to store”, the client terminal 1 stores the business data into the storage 15. When the storage attribute indicates “allowed to cache”, the terminal 1 stores the business data only into the Cache memory 16. In the latter case, whenever the client terminal 1 is turned off, or the application for browsing the business data is terminated, the business data stored in the cache memory 16 will disappear. It is therefore possible to ensure the security level of business data which have especially high confidentiality.

In the above, the acquisition process of business data in the browsing system 50 of the illustrative embodiment has been described. Next, the browsing process of business data in the browsing system 50 will be described.

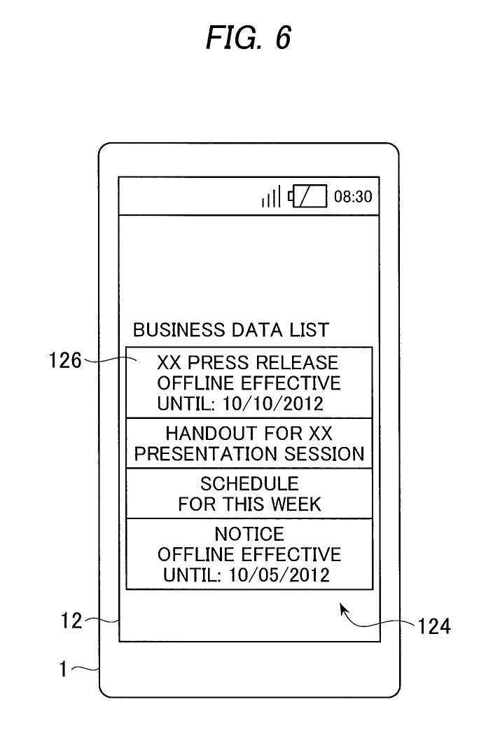

The client terminals 1 may acquire business data, and thereafter display a list of stored business data on the display 12 as described so far. FIG. 6 illustrates an example of a display screen of a client terminal 1. As understood from FIG. 6, the client terminal 1 may display the list 124 of the business data held in the client terminal itself on the display 12.

The user taps a displayed item of the business data he or she wishes to browse to thereby instruct browsing. If the business data are associated with the retention period information, the item 126 of the business data includes the retention period information displayed, as shown in FIG. 6, at the line “Offline effective until:”. By this means, the user can intuitively understand the retention period of the business data. Although not illustrated in FIG. 6, when the business data are associated with positional information where browsing is permitted and/or time period of the day information in which browsing is permitted, the client terminal 1 may display the positional information and/or the time period of the day information on the display 12 together with the item 126 of the business data.

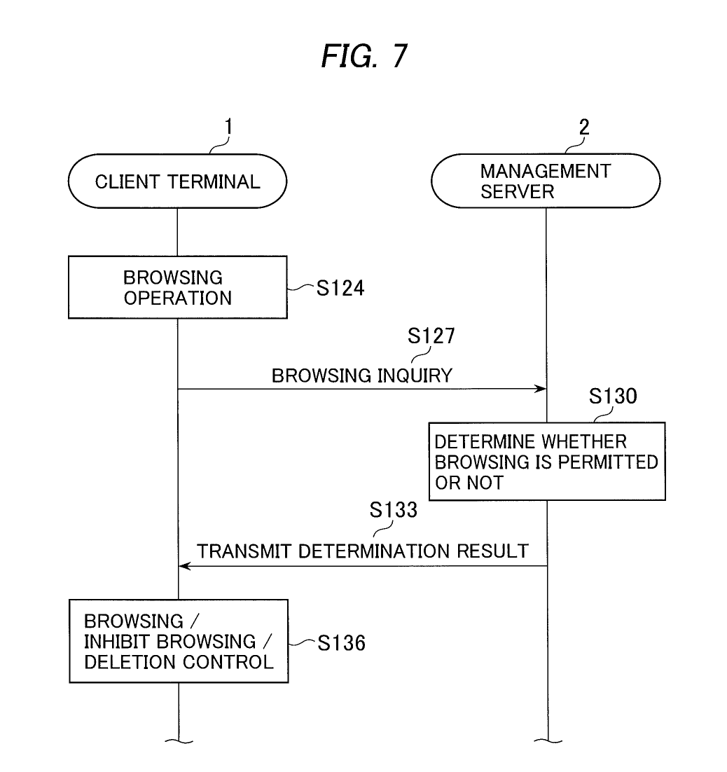

In addition, when browsing is requested on business data associated with browsing conditions, such as a retention period, a position where browsing is permitted or a time period of the day in which browsing is authorized, the client terminals 1 send a browsing inquiry to the management server 2. Now, with reference to FIG. 7, it will be described how a browsing inquiry is processed in the illustrative embodiment.

FIG. 7 is a flowchart useful for understanding how to process the browsing process of business data in the illustrative embodiment. As shown in the figure, when the browsing controller 17 of the client terminal 1 first detects the operation by the user for browsing at step S124, the browsing controller 17 sends a browsing inquiry to the management server 2 at subsequent step S127.

At the time of sending the browsing inquiry, the browsing controller 17 of the client terminal 1 may acquire information on the current position of the client terminal 1 per se through the communication unit 14 to transmit the current position information to the management server 2 in addition to information, such as file name, for specifying the business data which are desired to browse. For example, the client terminals 1 can use signals received from the global positioning system (GPS) satellites to measure the current positions thereof.

Subsequently at step S130, the determining unit 23 of the management server 2 is responsive to the browsing inquiry from the client terminal 1 to determine whether or not browsing of the business data is permitted. Specifically, the determining unit 23 uses the information included in the browsing inquiry, e.g. file name, for specifying the business data desired to browse to refer to the browsing conditions associated with the business data to thereby determine whether or not the browsing conditions are satisfied.

At step S133, the management server 2 transmits the result of determination on browsing permission to the client terminal 1 which has sent that browsing inquiry. The management server 2 may transmit the latest retention. period information together with the determination result.

At following step S136, the browsing controller 17 of the client terminal 1 performs the browsing permission control or the browsing inhibition control depending on the determination result. In addition, the management server 2 has determined that the browsing is not permitted because of the retention period having expired, the deletion controller 19 of the client terminal 1 performs a control such as to delete the business data concerned held in the client terminal itself. Moreover, when the client terminal 1 obtains the latest retention period information along with the determination result, the client terminal 1 performs an update control such as to make the latest retention period information associated with the business data held in the client terminal 1.

In short, in the browsing system 50 according to the illustrative embodiment, the client terminals 1 send a browsing inquiry to the management server 2 in order to perform the browsing permission, i.e. display, control on business data held in the client terminals, and the management server 2 can thereby manage the retention periods of the transmitted business data. According to the business data browsing system 50 of the illustrative embodiment, it is thus possible to improve the security level and convenience of business data held in the user terminals.

Specifically, the client terminals 1 reference the storage attribute associated with business data acquired from the management server 2 to perform a control such as to store the business data into the storage 15 or in the cache memory 16. By this means, upon the client terminals 1 being turned off, or the application for browsing business data being terminated, the business data stored in the cache memory 16 disappears. It is therefore possible to ensure the security level of business data having especially higher confidentiality.

Moreover, the client terminals 1 may send a browsing inquiry to the management server 2 when performing the browsing permission control of business data held in the client terminals, and the management server 2 can thereby manage the retention period of the transmitted business data.

While the present invention has been described with reference to the particular illustrative embodiment, it is not to be restricted by the embodiment. It is to be appreciated that those skilled in the art can change or modify the embodiment without departing from the scope and spirit of the present invention.

For example, the determining unit 23 of the management server 2 in the illustrative embodiment may be adapted to determine whether or not browsing is permitted by referencing information on the schedule and/or address book of the user in addition to the retention period information described above.

For example, the determining unit 23 may also be adapted for determining that browsing is permitted when the current moment is within a retention period defined by the retention period information and the keywords with which the business data are tagged and/or the position of the client terminal 1 match the user's schedule. The information on a user's schedule may be user's schedule information stored in the business data database 27, for example, “the schedule for this week” illustrated in FIG. 3.

The determining unit 23 may also be adapted such that, if the present moment is in a retention period defined by the retention period information and if keywords, e.g. company name, with which the business data are tagged and an address or location extracted by referencing an address book correspond to the current position of a client terminal 1, it is determined that browsing is permitted. Information on address books may be stored in the business data database 27.

The server 2 and the user terminals 1 in the illustrative embodiment are depicted and described as configured by separate functional blocks, such as the communication unit 25 and the controller 20. It is however to be noted that such a depiction and a description do not restrict the server 2 and the user terminals 1 to an implementation only in the form of hardware but the server 2 and the user terminals 1 may partially or entirely be implemented by software, namely, by a computer, or processor system, which has a computer program installed and functions, when executing the computer program, as part of, or the entirety of, the server and the user terminal. In this connection, the word “circuit” or “unit” may be understood not only as hardware, such as an electronics circuit, but also as a function that may be implemented by software installed and executed on a computer.

According to one implementation of the server 2, there is provided a non-transitory computer-readable storage medium storing a program, or a program product, for causing a computer to function as components of the server 2, or for causing a computer to execute the above-described steps performed by the server 2. According to another implementation of the client terminals 1, there is provided a non-transitory computer-readable storage medium storing a program, or a program product, for causing a computer to function as components of the user terminals 1, or for causing a computer to execute the above-described steps performed by the user terminals 1.

The entire disclosure of Japanese patent application No. 2012-209720 filed on Sep. 24, 2012, including the specification, claims, accompanying drawings and abstract of the disclosure, is incorporated herein by reference in its entirety.

What is claimed is:

1. A server comprising:
a manager which makes retention period information associated with data of a user to be stored into a database;
a determiner which is operative in response to a browsing inquiry of the data held in a user terminal to reference the retention period information of the data stored in the database to thereby determine whether or not access to the data is authorized to produce a determination result; and
a transmitter which transmits the determination result toward the user terminal.

2. The server according to claim 1, wherein the data are business data.

3. The server according to claim 2, wherein, when the retention period information has been updated, said transmitter transmits latest retention period information to the user terminal together with the determination result.

4. The server according to claim 2, further comprising a retriever which is operative in response to an acquisition request from the user terminal to retrieve the business data from the database,
wherein said transmitter transmits the business data retrieved by said retriever together with the retention period information associated with the business data.

5. The server according to claim 2, wherein said manager makes the business data associated with a storage attribute to store the business data associated with the storage attribute into the database, and
said transmitter transmits the business data according to an acquisition request from the user terminal to the user terminal together with the storage attribute.

6. The server according to claim 5, wherein the storage attribute is an allowance of storing or an allowance of caching.

7. The server according to claim 2, wherein, when the present date and time is within a retention period indicated by the retention period information, said determiner determines that the browsing is permitted.

8. The server according to claim 7, wherein said manager makes the business data associated with positional information on a position where browsing is permitted to store the business data associated with the positional information into the database stores, and
said determiner further determines, when a browsing place of the user terminal is in a vicinity of a position indicated by the positional information, that the browsing is permitted.

9. The server according to claim 7, wherein said determiner further determines, when schedule information of the user matches a keyword with which the business data are tagged, that the browsing is permitted.

10. The server according to claim 2, further comprising a receiver which is connected to a local area network of a business entity to which the user belongs, and receives the business data from an information processing device on the local area network,
wherein said manager stores the business data received from the information processing device into the database.

11. A user terminal comprising:
a communication unit which is operative in response to operation of a user requesting browsing of data held in said user terminal to send a browsing inquiry to a server; and
a controller which is operative in response to a determination result sent from the server according to retention period information of the data to control whether or not the access to the data is authorized.

12. The server according to claim 11, wherein the data are business data.

13. The user terminal according to claim 11, wherein, when the server has determined that the browsing is not permitted because of a retention period indicated by the retention period information having expired, said controller performs a control such as to delete the business data.

14. The user terminal according to claim 11, wherein, when the server has determined that the browsing is permitted because of current time being within a retention period indicated by the retention period information, said controller performs a browsing permission control of the business data.

15. The user terminal according to claim 11, wherein, when the server has determined that browsing is not permitted, although the current time is within a retention period indicated by the retention period information, because of said terminal being out of a browsing-allowable position which is indicated by positional information on a position where browsing is permitted, the positional information being associated with the business data, said controller performs a control such as to inhibit the browsing of the business data.

16. The user terminal according to claim 11, wherein, when the server has determined that the browsing is not permitted because of current time being within a retention period indicated by the retention period information, although schedule information of the user does not corresponds to a keyword with which the business data are tagged, said controller performs a control such as to inhibit the browsing of the business data.

17. The user terminal according to claim 11, wherein, when the browsing inquiry cannot be sent to the server, said controller references the retention period information associated with the business data held in said user terminal to determine whether or not the browsing is permitted.

18. The user terminal according to claim 11, wherein said controller performs an updating control so that latest retention period information acquired together with the determination result is made associated with the business data held in said user terminal.

19. The user terminal according to claim 11, wherein said communication unit sends an acquisition request of the business data to the server, and
said controller performs a storing control over the business data, acquired in response from the server, in accordance with a storage attribute acquired together with the business data.

20. The user terminal according to claim 19, wherein said controller stores the business data acquired from the server into a nonvolatile memory when the storage attribute is an allowance of storing, and into a volatile memory when the storage attribute is an allowance of caching.

21. A non-transitory computer-readable storage medium storing a program for causing a computer to function as a server which comprises:
a manager which makes retention period information associated with data of a user to be stored into a database;
a determiner which is operative in response to a browsing inquiry of the data held in a user terminal to reference the retention period information of the data stored in the database to thereby determine whether or not access to the data is authorized to produce a determination result; and
a transmitter which transmits the determination result toward the user terminal.

22. A non-transitory computer-readable storage medium storing a program for causing a computer to function as a user terminal which comprises:
a communication unit which is operative in response to operation a user requesting browsing of data held in the user terminal to send a browsing inquiry to a server; and
a controller which is operative in response to determination result sent from the server according to retention period information of the data to control whether or not the access to the data is authorized.
